(19) United States
(12) Patent Application Publication
(10) Pub. No.: US 2017/0061482 A1
(43) Pub. Date: Mar. 2, 2017

(54) FOCAL-POINT BASED RECOMMENDATION METHOD AND SYSTEM

(71) Applicant: TCL RESEARCH AMERICA INC., San Jose, CA (US)

(72) Inventors: LIFAN GUO, San Jose, CA (US); GUANHONG LI, San Jose, CA (US); HAOHONG WANG, San Jose, CA (US)

(73) Assignee: TCL RESEARCH AMERICA INC.

(21) Appl. No.: 14/833,160

(22) Filed: Aug. 24, 2015

(51) Int. Cl. G06Q 30/02

(52) U.S. Cl. CPC G06Q 30/0255; G06Q 30/0257; G06Q 30/0267

(57) ABSTRACT

The present invention provides a focal-point based recommendation method and system. The method includes collecting textual information displayed on a screen of the mobile terminal; identifying one or more focal points on the screen from a user; collecting contextual information of the mobile terminal; and suggesting one or more point-of-interests (POIs) to the user based on the textual information, the focal points and the contextual information. Further, when the user selects one or more POIs, based on the selected POIs, one or more contents are recommended to the user. The contents include at least one of an app content and an app function.

### FIELD OF THE DISCLOSURE

The present disclosure relates to the field of information technologies and, more particularly, relates to a focal-point based recommendation method and system.

### BACKGROUND

Nowadays, mobile applications (app) occupy a large share in people's daily life. Average users generally have 65 apps installed on their mobile devices. Users spend more time using the apps, about 94 minutes per day, than surfing the internet. However, average users only run 15 apps per week. Most of the apps installed on devices are used much less frequently. There are several reasons for such discrepancy. First, users may experience significant difficulties while expressing their needs. Further, when attempting to use an uncommon or rarely used function of an app, users may encounter difficulties in most cases. This is due to, in part, the fact that app developers continue to add more features and contents to the existing apps, without simplifying the existing ones. Moreover, app developers often fail to design apps with interfaces and functions adaptable to the behavior of users or to build a system adaptive to the behaviors of a plurality of users. In most cases, the profit of an app is directly proportional to its usage frequency. Therefore, an app with increased complexity may lead to a drop in usage percentage, which generally results in decreased profits.

In this context, according to the present disclosure, prediction of users' next steps in a mobile terminal may help match user needs with services provided by apps to alleviate the problems aforementioned. The disclosed method and system are directed to solve one or more problems set forth above and other problems.

### BRIEF SUMMARY OF THE DISCLOSURE

One aspect of the present disclosure provides a focal-point based recommendation method. The method includes collecting textual information displayed on a screen of the mobile terminal; identifying one or more focal points on the screen from a user; collecting contextual information of the mobile terminal; and suggesting one or more point-of-interests (POIs) to the user based on the textual information, the focal points and the contextual information. Further, when the user selects one or more POIs, based on the selected POIs, one or more contents are recommended to the user. The contents include at least one of an app content and an app function.

Another aspect of the present disclosure provides a focal-point based recommendation system. The system may include a point-of-interest (POI) recognizer, a user focus recognizer, a contextual recognizer, a focal-point based model module, and a search and recommendation engine. The POI recognizer may be configured to collect textual information displayed on the screen of the mobile terminal. The user focus recognizer may be configured to identify one or more focal points on the screen from a user. The contextual recognizer may be configured to collect contextual information of the mobile terminal. The focal-point based model module may be configured to suggest one or more POIs to the user based on the textual information from the POI recognizer, the focal points from the user focus recognizer and the contextual information from the contextual recognizer. The search and recommendation engine may be configured to recommend one or more contents to the user based on one or more POIs selected by the user. The contents include at least one of an app content and an app function.

### BRIEF DESCRIPTION OF THE DRAWINGS

The following drawings are merely examples for illustrative purposes according to various disclosed embodiments and are not intended to limit the scope of the present disclosure.

FIG. 1 illustrates an exemplary operating environment incorporating certain embodiments consistent with the present disclosure;

FIG. 2 illustrates a block diagram of an exemplary computing system consistent with the disclosed embodiments;

FIG. 3 illustrates a system architecture of an exemplary focal-point based recommendation system consistent with the disclosed embodiments;

FIG. 4 illustrates a flow chart of an exemplary focal-point based recommendation process consistent with the disclosed embodiments;

FIG. 5 illustrates a schematic diagram of an exemplary focal-point enhanced conditional random field model consistent with the disclosed embodiments;

FIG. 6 illustrates a schematic diagram of an exemplary search and recommender engine consistent with the disclosed embodiments; and

FIG. 7 illustrates an example operation of an exemplary focal-point based recommendation system consistent with the disclosed embodiments.

### DETAILED DESCRIPTION

Reference will now be made in detail to exemplary embodiments of the invention, which are illustrated in the accompanying drawings. Hereinafter, embodiments consistent with the disclosure will be described with reference to the drawings. Wherever possible, the same reference numbers will be used throughout the drawings to refer to the same or like parts. It is apparent that the described embodiments are some but not all of the embodiments of the present invention. Based on the disclosed embodiments, persons of ordinary skill in the art may derive other embodiments consistent with the present disclosure, all of which are within the scope of the present invention.

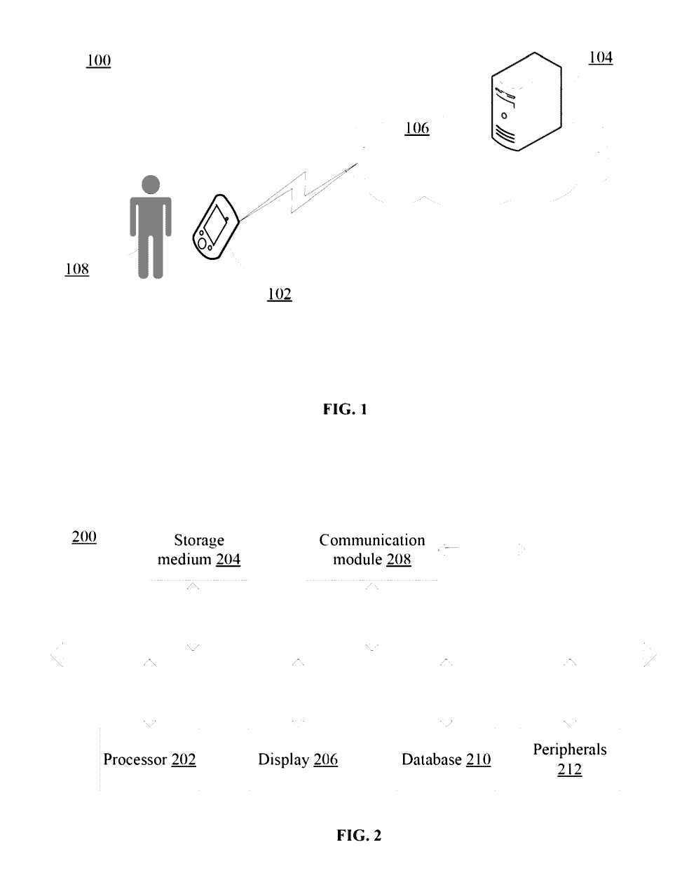

FIG. 1 illustrates an exemplary environment 100 incorporating certain disclosed embodiments. As shown in FIG. 1, environment 100 may include a terminal 102, a server 104, and a network 106. A user 108 may operate terminal 102 to access network 402 for certain services provided by server 104. Although only one server 104 and one terminal 102 is shown in the environment 100, any number of terminals 102 or servers 104 may be included, and other devices may also be included.

Network 106 may include any appropriate type of communication network for providing network connections to terminal 102 and server 104 or among multiple terminals 102 and servers 104. For example, network 106 may include the Internet or other types of computer networks or telecommunication networks, either wired or wireless.

A terminal, as used herein, may refer to any appropriate user terminal with certain computing capabilities, such as a personal computer (PC), a work station computer, a server computer, a hand-held computing device (tablet), a smart phone or mobile phone, or any other user-side computing device. In certain embodiments, terminal 102 may be a wireless terminal, such as a smart phone, a tablet computer, or a mobile phone, etc.

A terminal (e.g., terminal 102) may include one or more clients. The client, as used herein, may include any appropriate application software, hardware, or a combination of application software and hardware to achieve certain client functionalities. For example, the client may be an app, such as a browser app, a map app, a shopping app, a social network service app, a messaging app, a service/merchant review app, etc. Further, an app may contain different contents and various app functions to provide corresponding services.

A server, as used herein, may refer to one or more server computers configured to provide certain web server functionalities to provide certain services, which may require any user accessing the services to authenticate to the server before the access, such as information search services. A web server may also include one or more processors to execute computer programs in parallel. The server may support various functionalities provided by the one or more clients on terminal 102.

Terminal 102 or server 104 may be implemented on any appropriate computing platform. FIG. 2 shows a block diagram of an exemplary computing system 500 capable of implementing terminal 102 and/or server 104.

As shown in FIG. 2, computer system 200 may include a processor 202, a storage medium 204, a display 206, a communication module 208, a database 210, and peripherals 212. Certain devices may be omitted and other devices may be included.

Processor 202 may include any appropriate processor or processors. Further, processor 202 can include multiple cores for multi-thread or parallel processing. Processor 202 may execute sequences of computer program instructions to perform various processes. Storage medium 204 may include memory modules, such as ROM, RAM, flash memory modules, and erasable and rewritable memory, and mass storages, such as CD-ROM, U-disk, and hard disk, etc. Storage medium 204 may store computer programs for implementing various processes, when executed by processor 202.

Further, communication module 208 may include network devices for establishing connections through the network 106. Database 210 may include one or more databases for storing certain data and for performing certain operations on the stored data, such as database searching.

Display 206 may include any appropriate type of computer display device or electronic device display (e.g., CRT or LCD based devices, touch screens). When display 206 is a touch screen, user hand gestures or gestures performed by a stylus may be tracked and recorded. Peripherals 212 may include various sensors and other I/O devices, such as cameras, motion sensors (e.g., accelerometer, gyroscope), environmental sensors (e.g., ambient light sensor, temperature and humidity sensor) and position sensors (e.g., proximity sensor, orientation sensor, and magnetometer). Further, peripherals 212 may apply eye-tracking technologies to track focal point of a user on display 206.

In operation, while a user is using terminal 102, terminal 102 may predict intentions of user and perform next desired actions. For example, once the intention is identified as “finding a restaurant”, terminal 102 may preload and prepare relevant apps in advance for a user to choose from, based on a recommendation system.

The recommendation system uses both textual information displaying on a mobile (e.g., terminal 102) screen and interactions between a user and the mobile terminal. Particularly, name entities displaying in real-time on a mobile screen, as used herein, may be referred to as Point-of-Interest (POI). For example, a name entity may be a name of a restaurant. Different POIs may potentially represent different user intentions and each POI may correspond to different functions that the user may perform in further steps.

In disclosed embodiments, the recommendation system may utilize point position on a mobile screen focused by a user to determine user intentions. The point may be a touch point by user gesture or a gaze point from an eye-tracking system. Therefore, the coordinate information of focal points on the mobile screen may be utilized to enhance a conditional random field model in determining which POI(s) may represent user intention.

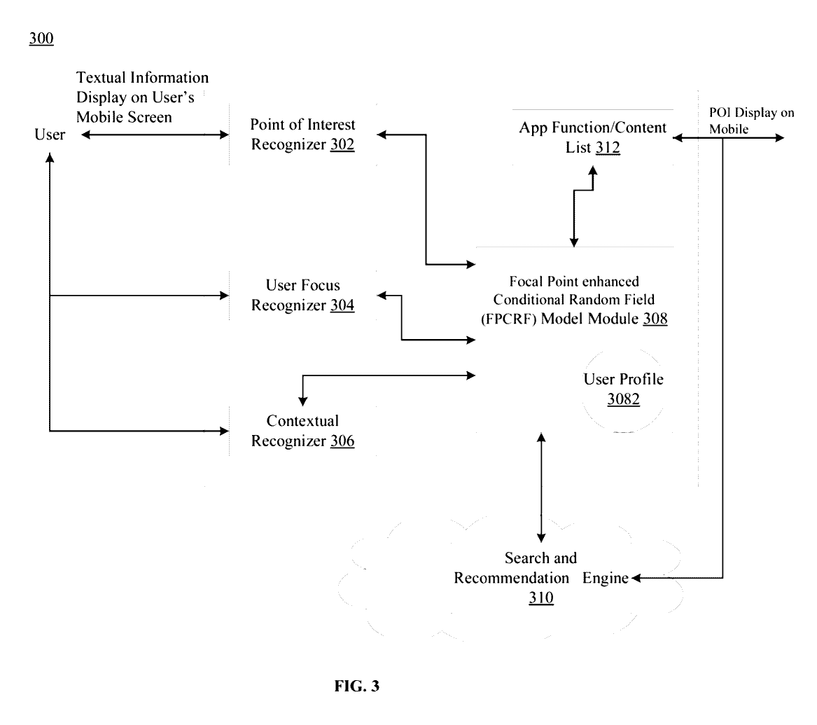

FIG. 3 shows a system architecture of an exemplary focal-point based recommendation system 300. The recommendation system 300 may be applied in a terminal (e.g., terminal 102) having a display screen and/or a server connected to the terminal (e.g., server 106). As shown in FIG. 3, the recommendation system 300 may include a point-of-interest (POI) recognizer 302, a user focus recognizer 304, a contextual recognizer 306, a focal-point enhanced conditional random field (FPCRF) model module 308, and a search and recommendation engine 310. Certain components may be omitted and other components may be added.

The point-of-interest recognizer 302 may be configured to find out POIs from textual information with corresponding coordinates displayed on the mobile screen recently (e.g., within the past few minutes). The point-of-interest recognizer 302 may segment POIs from displayed texts. A dictionary predefined in the mobile terminal may be used to segment POIs. The predefined dictionary may include words and phrases that may indicate user's interest. In some embodiments, when a word from displayed text matches a word in the dictionary, a POI is recognized. Further, in certain embodiments, when segmenting POIs, the POI recognizer may only extract nouns from the text data. Other non-relevant words or phrases may be excluded. The POI recognizer 302 may reduce non-relevant information by automatically selecting words or phrases that might potentially indicate interests of users. The segmented word candidates (i.e., POIs) are passed to the FPCRF model module 308.

In one embodiment, the POI recognizer 302 may process text information on the mobile screen regularly at a predefined time interval (e.g., every second) when the screen is on (e.g., a user is actively using the mobile terminal). For example, at a first second, the POI recognizer 302 may segment a first set of 5 candidate POIs from the text information displayed at this second. At a next second, the POI recognizer 302 may segment a second set of 3 candidate POIs from the text information displayed at this second. The candidate POIs may be saved in a stack-based buffer.

In another embodiment, the POI recognizer 302 may process text information on the mobile screen when the current screen changes. For example, at a previous screen, a user may be texting in a messaging app. The POI recognizer 302 may extract a set of candidate POIs from the messaging screen. At a current screen, the user may be browsing news in a browser app. The POI recognizer 302 may extract another set of candidate POIs from the browser screen. The candidate POIs may be saved in a stack-based buffer.

The user focus recognizer 304 may be configured to find out the position of a focal point on the mobile screen through interactions between a user and the mobile terminal. The focal point may be detected in different ways, including human mobile gestures, such as pointing, gesturing, grasping, shaking, tapping, or eye gaze tracking system. Further, the user focus recognizer 304 may send the recognized positions of focal points to the FPCRF model module 308.

The contextual recognizer 306 may be configured to collect contextual information through sensors on the mobile terminal. The contextual information may include, for example, time, location, etc. The contextual information may help disambiguate the user's intentions. The contextual recognizer 306 may send the collected contextual information to the FPCRF model 308.

Further, a conditional random field model may be applied to model short-term user interest on the mobile terminal. The condition random field model may analyze user context, user profile and POI information. In an exemplary embodiment, the conditional random field model may be the focal-point enhanced conditional random field (FPCRF) model.

The FPCRF model module 308 may be configured to identify POIs in different user contexts and recommend top POI by leveraging multi-model information collected from other modules (e.g., the POI recognizer 302, the user focus recognizer 304, the contextual recognizer 306, etc.). That is, focal points on the mobile screen, contextualized by the POI information displayed on the screen, may indicate information about user's interests. For example, if a user is interested in eating out in a restaurant, the user may gaze the position around the name of a restaurant appearing on the mobile screen.

The user profile 3082 may be configured to store user settings, preferences and user history, such as browsing history, app usage, previous selected POIs, favorite apps, frequently used app functions, etc. Further, according to collected information from other modules and related information from the user profile 3082, the FPCRF model module 308 may apply a conditional random field model to predict one or more top POIs that most possibly represent the user's interest. In some embodiments, the top POIs may be presented to the user on mobile screen for selection. In other embodiments, the FPCRF model module 308 may automatically select one or more top POIs. The selected POIs may be sent to the search and recommendation engine 310.

The search and recommendation engine 310 may be configured to search updated contents and/or functions associated with the received POIs in making personalized recommendation based on user's history information (e.g., saved in the user profile 3082). In certain embodiments, the search and recommendation engine 310 may use a cloud service to perform searches in online databases. Further, the search and recommendation engine 310 may provide a list (e.g., app function/content list 312) that recommends app functions and app contents most related to the received POI based on user's interest. The app function/content list 312 may be a ranked list and place the most related app function or app content on top of the list.

In operation, a user may be viewing textual information on the mobile screen. The exemplary recommendation system 300 on the mobile terminal may collect text data and extract POIs by the point-of-interest recognizer 302. The user focus recognizer 304 may collect focal points of the user. The contextual recognizer 306 may collect context information from sensors on the mobile terminal. Further, the FPCRF model module 308 may process the extracted POIs, collected focal points and the context information to rank the POIs according to user interest. The search and recommendation engine 310 may make personalized recommendation according to the top POI provided by the FPCRF model module 308. The personalized recommendation may include app contents and app functions provided in a ranked list.

In the disclosed embodiments, the exemplary recommendation system 300 may automatically infer the current interest of a user operating the mobile terminal, and generate predictions of whether a user is interested in the POIs appeared on the mobile screen. According to the predictions, the mobile terminal may dynamically adjust POI display strategy. That is, before showing POIs to the user, the recommendation system 300 may evaluate which POI may represent current interests of the user. Further, knowing the user interests in POI may allow the mobile terminal to prepare related apps in advance.

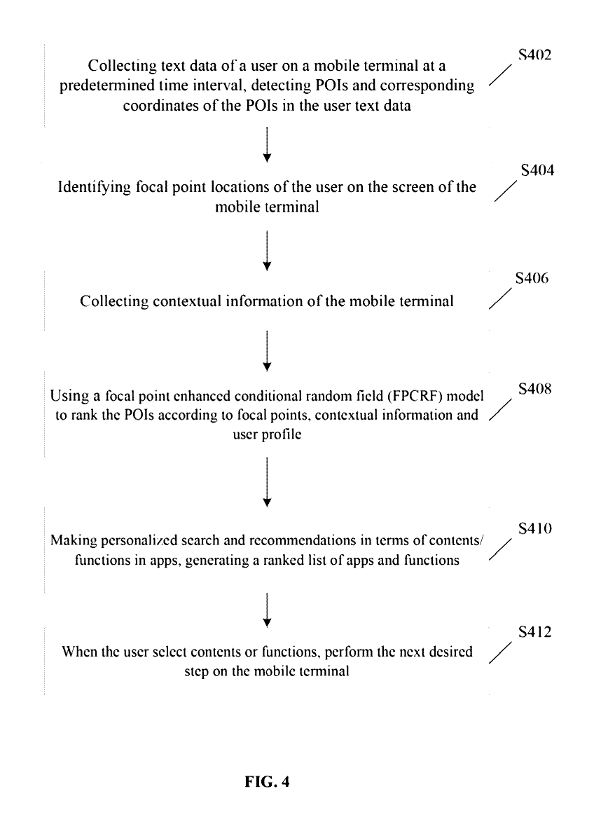

FIG. 4 illustrates a flow chart of an exemplary focal-point based recommendation process consistent with the disclosed embodiments. As shown in FIG. 4, a mobile terminal (e.g. terminal 102) may implicitly collect text data of a user at a predetermined time interval, such as every minute. The text data may include texts displayed on the mobile screen. The time interval may be configured differently according to different devices and depending on battery level of the mobile terminal. Candidate POIs and corresponding coordinates of the candidate POIs may be detected from user text data and stored in a stack based buffer (S402).

When a user interacts with the mobile terminal via, for example, gesture or eye gaze tracking system, the mobile terminal may identify location information of the focal point location on the display screen of the mobile terminal (S404). Further, contextual information may be collected, such as current time and location of the mobile terminal (S406).

Further, the detected candidate POIs and coordinate information of the candidate POIs, the coordinates of focal points, and the contextual information may be sent to a focal-point enhanced conditional random field (FPCRF) model. The FPCRF model may re-rank POIs from the buffer based on the coordinates distance between POIs and focal points, the contextual information, and user profile (S408).

Specifically, in an exemplary embodiment, a problem in predicting users' interests for POIs may be formulated. The first i POIs of the user behavior within T time may be denoted as P (P₁, . . . , Pᵢ). The first i POIs may be used for training. For example, first i POIs may be detected POIs from previous screens within T time. The user contextual information on the mobile terminal for the ith POI may include location lᵢ and time tᵢ. The coordinates of a mth POI may be denoted as (xₘ, yₘ). The coordinates of a focal pointer (e.g., from finger touch, eye-tracking, etc.) may be denoted as (x_{f}, y_{f}). The model may aim to predict whether the user would click on the results for any of the current POIs: Pᵢ₊ᵢ, . . . , Pₘ extracted from texts in the current screen. Various types of information captured from different sources may be represented as different features in the FPCRF model, including positions of POIs, positions of focal points, contextual information, currently running apps, previous selected POI, etc. The captured information and corresponding feature representations are explained in detail in the following paragraphs.

To extract information hidden in the user focal points (e.g., finger touches) on the mobile screen, Euclidean distance may be used to calculate the distance between a finger touch pointer (x_{f}, y_{f}) and a POI position (xᵢ, yᵢ) on the screen to represent a user's current interest in POI. Then, the value may be normalized based on different mobile screen size. The normalized Euclidean distance d(f,i) may be calculated using equation (1).

$$d ( f , i ) = \frac{1}{Normalizer} \sqrt{{( {x}_{f} - {x}_{i} )}^{2} + {( {y}_{f} - {y}_{i} )}^{2}} \qquad ( 1 )$$

Contextual features may include current location, time, date and battery level that collected from the mobile terminal. The context data may be discretized and converted into discrete values. For example, the location data may be classified into major location categories, such as home, work, and outside. The time data may be categorized into morning, noon, afternoon and evening. The date information may be categorized into workday and weekend. The battery level may be represented by 10 equal-sized levels from 1-10.

Further, apps currently running on the mobile terminal may indicate next desired step of the user. Thus, descriptions of apps currently running on the mobile terminal may be utilized. These features may be represented as bag of words. In addition, previous click information of POI may be included as a binary feature.

FIG. 5 illustrates an exemplary modeling process of the focal-point enhanced conditional random field model consistent with the disclosed embodiments. Specifically, a conditional probability is defined as the probability of a hidden state 502 given a particular observation sequence 504 of POIs. The hidden states 502 may include R and N, respectively corresponding to “user is interested in” and “user is not interested in”. The observation sequence 504 of a POI may include but not limited to the normalized Euclidean distance between the focal point and the POI, the contextual features (e.g., location, time, date, and battery level), features about currently running apps (not shown).

During the training stage, the hidden state is assigned to a POI based on whether the POI is clicked in the past. During prediction phase, given a sequence of observations (including context features and interaction features) of a to-be-categorized POI, the model may recover the label sequence (i.e., hidden state) that maximizes the conditional probability of the observation sequence. Further, the predicted POIs with an R state may be outputted and displayed on the screen of the mobile terminal.

Returning to FIG. 4, when the user selects one or more POIs, according to the selected POIs and user's context, the mobile terminal may make personalized search and recommendations in terms of contents/functions in apps (S410). Specifically, a search and recommendation engine (e.g. search and recommendation engine 310) may be employed to identify apps or app functions according to the selected POI and user profile.

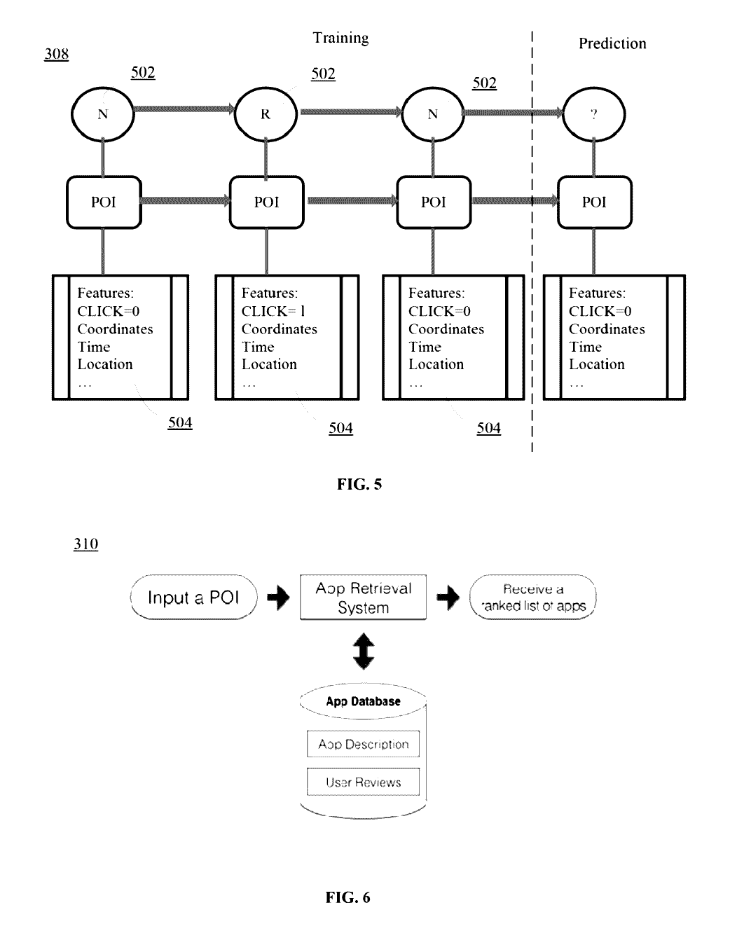

FIG. 6 shows an exemplary search and recommendation engine consistent with the present disclosure. After receiving the selected POIs, the search and recommendation engine 310 may retrieve apps and/or functions related to each POI from an app database. The app database may include a plurality of apps and functions, and corresponding descriptions and reviews of the apps and the functions. The search and recommendation engine 310 may rank the retrieved apps and/or functions based on the corresponding descriptions and reviews. Further, the ranked app function/content list associated to each selected POI may be outputted.

In certain embodiments, Query Likelihood (QL) score may be calculated to generate a ranked list of relevant apps and/or functions. Specifically, for each app, the corresponding description and user reviews are preprocessed to generate a bag of words. Given each POI denoted as poi, words included in the POI denoted as w, an app/function denoted as d, the QL score of an app/function d with respect to a POI p may be calculated using equation (2).

$$SCORE ( poi , d ) = {\prod }_{w ∈ poi} p ( w \vert d ) = {\prod }_{w ∈ poi} ( 1 - μ ) {p}_{m l} ( w \vert d ) + μ p ( w \vert D ) \qquad ( 2 )$$

In equation (2), D denotes the App corpus. pₘₗ(w|d) and p(w|D) are estimated by Maximum Likelihood Estimator (MLE). μ denotes a smoothing parameter. In certain embodiments, a Jelinek Mercer smoothing technique may be used for the smoothing parameter μ.

Returning to FIG. 4, when the ranking list is displayed on the screen, the user may then select contents or functions to perform the next desired step on the mobile terminal (S412). Meanwhile, user selections may be used to update user profile in FPCRF model for future prediction.

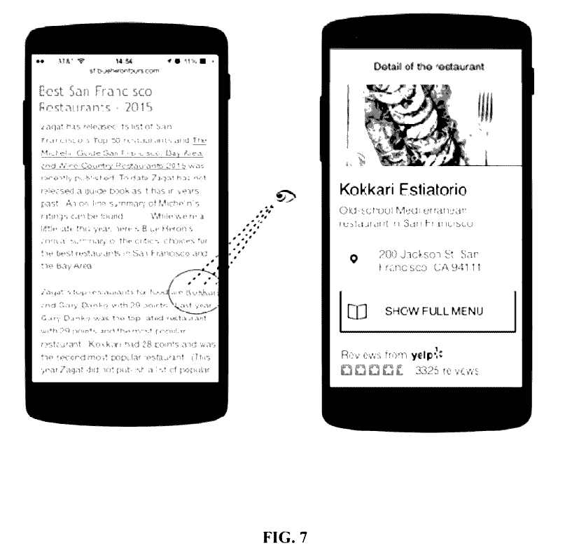

FIG. 7 illustrates an example operation of an exemplary focal-point based recommendation system (e.g. system 300) consistent with the present disclosure. A user may receive a message from his/her friend. The POI recognizer 302 may recognize a plurality of POIs in the backend. For example, As shown on the left side of FIG. 7, the recognized POIs (e.g., words and phrases in blue color in FIG. 7) may include two restaurant names: “kokkari estiatorio” and “gary danko”. The user may interact with the mobile terminal, such as, gazing the screen. The location of focal points of the user may be collected (e.g., indicated by the red circle).

Further, the focal-point enhanced conditional random field (FPCRF) model may recommend one or more POIs (e.g., words with red underlines in FIG. 7) with the highest probability according to the collected information. In some embodiments, the recommended POIs may be presented in a prompt window on the mobile screen to allow user selection. For example, one POI with the highest probability may be “kokkari”. Further, after user confirms the prediction of the POI “kokkari” (e.g., by clicking the word), the functions associated with the POI indicating next desired movement may be recommended via the search and recommendation engine 310 on the cloud. For example, the app functions may include displaying introductory information of the restaurant (e.g., cuisine type, address, picture), providing an option to show full menu, and/or providing an option to list reviews from Yelp, as shown on the right side of FIG. 7.

Thus, the present disclosure provides a frame work to predict next desired movement on a mobile terminal. Textual information displayed on the screen and interactions between a user and the mobile terminal may be integrated for predictions. From the aspect of user experience, significant difficulties experienced by a user to match his/her needs with mobile services may be reduced. Further, in the disclosed embodiments, focal point information of a user on mobile screen may be utilized to enhance the recommendation system when recognizing intentions of the user.

Moreover, the present disclosure provides a conditional random filed probability model to jointly utilize heterogeneous information from user side to predict the next movement. This approach may provide a natural user experience that could non-intrusively capture user's interests and recommend user next step.

In the disclosed embodiments, a mobile terminal is used as an example. It is understood that the disclosed system and method may be applied to other devices with displays, such as tablet, PC, watch and so on, to predict user's preference from multi-modal information. The present disclosure may provide a unique user experience mode to enrich people's lives.

Other embodiments of the disclosure will be apparent to those skilled in the art from consideration of the specification and practice of the invention disclosed herein. It is intended that the specification and examples be considered as exemplary only, with a true scope and spirit of the invention being indicated by the claims.

What is claimed is:

1. A recommendation method for a mobile terminal, comprising:
collecting textual information displayed on a screen of the mobile terminal;
identifying one or more focal points on the screen from a user;
collecting contextual information of the mobile terminal;
based on the textual information, the focal points and the contextual information, suggesting one or more point-of-interests (POIs) to the user; and
when the user select one or more POIs, based on the selected POIs, recommending one or more contents to the user, wherein the contents include at least one of an app content and an app function.

2. The recommendation method according to claim 1, wherein collecting textual information displayed on the screen of the mobile terminal further comprises:
extracting candidate POIs from the textual information collected within a predetermined time period;
obtaining corresponding coordinates of the candidate POIs; and
storing the candidate POIs and the corresponding coordinates in a stacked buffer.

3. The recommendation method according to claim 1, wherein identifying one or more focal points on the screen from the user further comprises at least one of:
recording coordinates of a touch point when the user touches the screen, wherein the coordinates of the touch point is a focal point; and
recording coordinates of an eye-gazing point by an eye-tracking system when the user looks at the screen, wherein the coordinates of the eye-gazing point is a focal point.

4. The recommendation method according to claim 1, wherein the contextual information of the mobile terminal includes at least one of current location, current time, current text data, and current battery level.

5. The recommendation method according to claim 2, wherein suggesting one or more point-of-interests (POIs) to the user further comprises:
generating a plurality of features for the candidate POI based on the textual information, the focal points and the contextual information; and
applying a conditional random field model to predict whether a candidate POI is a desired POI, including:
at a training phase, assigning binary states to previous POIs based on whether a previous POI is selected by the user, and collecting the plurality of features for the previous POIs;
at a prediction phase, determining a label of the candidate POI that maximizes a conditional probability given the plurality of features for the candidate POI, wherein the label includes a state indicating that the candidate POI is a desired POI, and a state indicating that the candidate POI is not a desired POI.

6. The recommendation method according to claim 5, wherein the plurality of features for a POI comprises at least one of: a distance between a focal point and the POI, current location, current time, current data, and current battery level.

7. The recommendation method according to claim 6, wherein calculating a distance between a focal point and a POI further comprises:
calculating a Euclidean distance between the focal point and the POI;
normalizing the calculated Euclidean distance according to a size of the screen of the mobile terminal; and
obtaining the normalized distance as the distance between the focal point and the POI.

8. The recommendation method according to claim 1, wherein recommending one or more contents to the user further comprises:
searching descriptions and reviews of a plurality of app contents and app functions;
ranking the app contents and the app functions according to relevance of the descriptions and the reviews to the selected POI; and
presenting a ranked list of app contents and app functions on the screen.

9. The recommendation method according to claim 1, wherein ranking the app contents and the app functions further comprises:
preprocessing the descriptions and the reviews to generate a corresponding bag of words;
calculating a query likelihood score of a content with respect to the selected POI; and
ranking the app contents and the app functions according to the query likelihood scores.

10. A recommendation apparatus for a mobile terminal having a screen, comprising:
a point-of-interest (POI) recognizer configured to collect textual information displayed on the screen of the mobile terminal;
a user focus recognizer configured to identify one or more focal points on the screen from a user;
a contextual recognizer configured to collect contextual information of the mobile terminal;
a focal-point based model module configured to suggest one or more POIs to the user based on the textual information from the POI recognizer, the focal points from the user focus recognizer and the contextual information from the contextual recognizer; and
a search and recommendation engine configured to recommend one or more contents to the user based on one or more POIs selected by the user, wherein the contents include at least one of an app content and an app function.

11. The recommendation apparatus according to claim 10, wherein the POI recognizer is further configured to:
extract candidate POIs from the textual information collected within a predetermined time period;
obtain corresponding coordinates of the candidate POIs; and
store the candidate POIs and the corresponding coordinates in a stacked buffer.

12. The recommendation apparatus according to claim 10, wherein the user focus recognizer is further configured to perform at least one of:
recording coordinates of a touch point when the user touches the screen, wherein the coordinates of the touch point is a focal point; and
recording coordinates of an eye-gazing point by an eye-tracking system when the user looks at the screen, wherein the coordinates of the eye-gazing point is a focal point.

13. The recommendation apparatus according to claim 10, wherein the contextual information of the mobile terminal includes at least one of current location, current time, current data, and current battery level.

14. The recommendation apparatus according to claim 11, wherein the focal-point based model module is further configured to:
generate a plurality of features for the candidate POI based on the textual information, the focal points and the contextual information; and
apply a conditional random field model to predict whether a candidate POI is a desired POI, including:
at a training phase, assigning binary states to previous POIs based on whether a previous POI is selected by the user, and collecting the plurality of features for the previous POIs;
at a prediction phase, determining a label of the candidate POI that maximizes a conditional probability given the plurality of features for the candidate POI, wherein the label includes a state indicating that the candidate POI is a desired POI, and a state indicating that the candidate POI is not a desired POI.

15. The recommendation apparatus according to claim 14, wherein the plurality of features for a POI further comprises at least one of: a distance between a focal point and the POI, current location, current time, current data, and current battery level.

16. The recommendation apparatus according to claim 15, wherein calculating a distance between a focal point and a POI further comprises:
calculating a Euclidean distance between the focal point and the POI;
normalizing the calculated Euclidean distance according to a size of the screen of the mobile terminal; and
obtaining the normalized distance as the distance between the focal point and the POI.

17. The recommendation apparatus according to claim 10, wherein the recommendation and search engine is further configured to:
search descriptions and reviews of a plurality of app contents and app functions;
rank the app contents and the app functions according to relevance of the descriptions and the reviews to the selected POI; and
present a ranked list of app contents and app functions on the screen.

18. The recommendation apparatus according to claim 17, wherein ranking the app contents and the app functions further comprises:
preprocessing the descriptions and the reviews to generate a corresponding bag of words;
calculating a query likelihood score of a content with respect to the selected POI; and
ranking the app contents and the app functions according to the query likelihood scores.
